(19) United States
(12) Patent Application Publication
(10) Pub. No.: US 2025/0303849 A1
(43) Pub. Date: Oct. 2, 2025

(54) COMBINED MOTOR ROTOR AND WHEEL RIM ASSEMBLY

(71) Applicant: Ford Global Technologies, LLC, Dearborn, MI (US)

(72) Inventors: Mark Thomas Weston, Livonia, MI (US); Keith Weston, Canton, MI (US)

(21) Appl. No.: 18/623,398

(22) Filed: Apr. 1, 2024

(51) Int. Cl. B60K 7/00; B60B 3/16; B60B 21/00; B60B 27/00; B60L 50/60; H02K 7/102; H02K 9/06; H02K 11/33; H02K 13/00

(52) U.S. Cl. CPC B60K 7/0007; B60B 3/16; B60B 21/00; B60B 27/0047; H02K 7/102; H02K 9/06; H02K 11/33; H02K 13/003; B60B 2310/202; B60B 2310/208; B60B 2900/1216; B60K 2007/0038; B60K 2007/0061; B60L 50/60

(57) ABSTRACT

A wheel assembly for a vehicle may include a rim on which a tire is mountable, and an electric motor assembly operably coupled to the rim. The electric motor assembly may include a rotor, a stator and power electronics. The electric motor assembly may be operably coupled to a battery of the vehicle to provide motive force to the rim to rotate the tire with the rim responsive to application of a rotating electric field in the stator that causes corresponding rotation of the rotor under control of the power electronics. The rim and the rotor are integrally formed as a combined assembly without any fastening means therebetween.

### TECHNICAL FIELD

Example embodiments generally relate to vehicle wheel assemblies and, more particularly, relate to a wheel rim assembly that combines an electric motor rotor as part of a single assembly in order to remove unsprung weight of the wheel assembly.

### BACKGROUND

The unsprung weight of a vehicle is the total weight of all the parts of the vehicle that are not supported by the vehicle's suspension system. For electric vehicles, in-wheel hub motors typically mount to the wheel hub of the vehicle. A rim and tire assembly is then bolted to the wheel hub. The rotor of the hub motor will spin, in turn spinning the wheel hub, and therefore also spinning the rim and the tire. In this manner, the motor's rotational motion is transferred to the vehicle's linear motion where the tire meets the road surface.

The addition of a hub motor to a conventional configuration having just a rim and tire attached to the wheel hub has the disadvantage of undesirably adding more components to the wheel assembly as well as also adding to the unsprung weight of the vehicle. Accordingly, it may be desirable to provide an upgraded design that deals with both issues positively.

### BRIEF SUMMARY OF SOME EXAMPLES

In accordance with an example embodiment, a wheel assembly for a vehicle may be provided. The wheel assembly may include a rim on which a tire is mountable, and an electric motor assembly operably coupled to the rim. The electric motor assembly may include a rotor, a stator and power electronics. The electric motor assembly may be operably coupled to a battery of the vehicle to provide motive force to the rim to rotate the tire with the rim responsive to application of a rotating electric field in the stator that causes corresponding rotation of the rotor under control of the power electronics. The rim and the rotor are integrally formed as a combined assembly without any fastening means therebetween.

In another example embodiment, an electric motor assembly for a vehicle is provided. The electric motor assembly may include a battery, a rotor, a stator, and power electronics operably coupled to the battery to receive power for controlling application of current to the stator to generate a rotating electric field in the stator that causes corresponding rotation of the rotor under control of the power electronics. The electric motor assembly may be operably coupled to a wheel rim on which a tire is mountable. The rim and the rotor may be integrally formed as a combined assembly without any fastening means therebetween.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a block diagram of a conventional wheel assembly with an in-wheel hub motor;

FIG. 2 illustrates a block diagram of a wheel assembly in accordance with an example embodiment;

FIG. 3 illustrates an exploded view of components of a wheel assembly with a rim/rotor combined assembly in accordance with an example embodiment;

FIG. 4 illustrates a side view of a rim/rotor combined assembly having airflow generating elements of an example embodiment;

FIG. 5 illustrates an exploded perspective view of a rim/rotor combined assembly having aerodynamic vanes in accordance with an example embodiment;

FIG. 6 illustrates an exploded perspective view of a rim/rotor combined assembly having aerodynamic ducts in accordance with an example embodiment; and

FIG. 7 is a side view of an aerodynamic duct in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Some example embodiments described herein may reduce the unsprung mass on a vehicle that is driven by an electric motor assembly. In this regard, by integrating the rotor of the electric motor assembly into the wheel rim, the use of fasteners to hold two separate pieces together can be completely eliminated. Not only does that part count reduction simplify assembly and enhance efficiency, but it also reduced the unsprung mass of the vehicle in the combined assembly that results from this integration. Some example embodiments may also add airflow generation elements on the outside of the wheel (e.g., on a hub interface portion of the rim), and those airflow generation elements may direct air inwardly through the hub interface portion and through the rim toward the rotor and stator of the electric motor assembly (and also toward the brake assembly) to provide cooling to those assemblies that is in direct proportion to the speed of the vehicle and current draw of the electric motor assembly. Some example structures for achieving these goals are described hereafter by way of example and not of limitation.

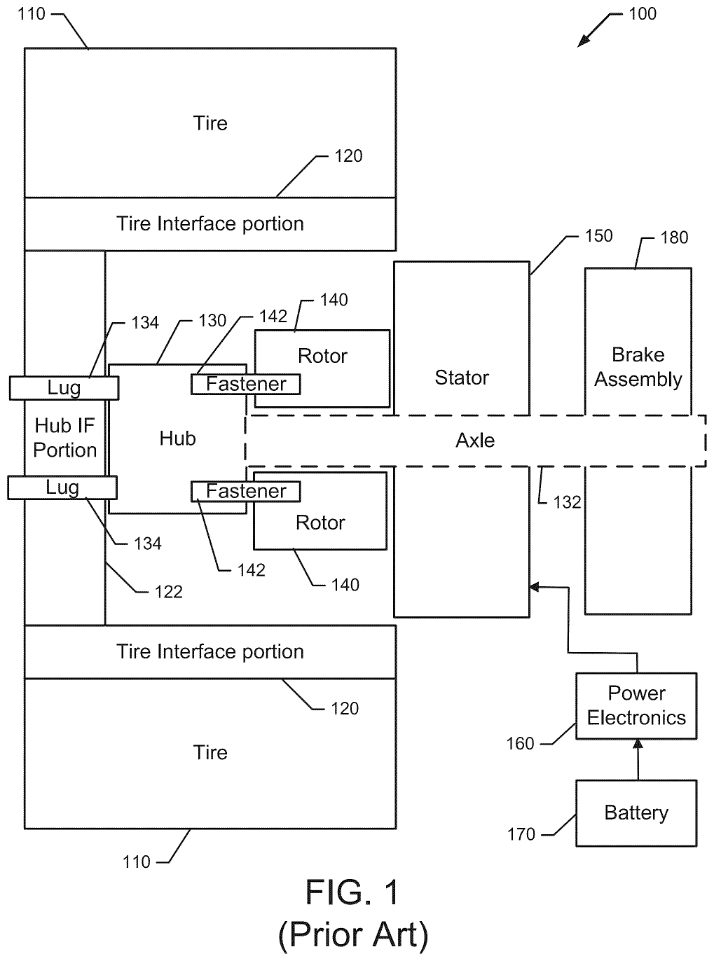

FIG. 1 illustrates a conceptual block diagram of a wheel assembly 100 from a cross sectional perspective. The section cut would be along the rotational axis of the wheel assembly 100, and therefore tire 110 is shown in two parts, the top part representing the top portion of the tire 110 that is on top of or above the rim, and the bottom part representing the bottom portion of the tire 110 that is below the rim and in contact with the ground. The rim itself is represented by two functionally (and often physically) different sections including a tire interface portion 120 and a hub interface portion 122. The tire interface portion 120 typically includes structures for interfacing with and retaining the bead of the tire 110 to provide a seal for air retained in the tire 110 between the tire 110 and the tire interface portion 120. The tire interface portion 120 therefore generally includes metallic structure that extends substantially parallel to the rotational axis of the wheel assembly 100 around the axis to define a somewhat cylindrical structure.

Meanwhile, the hub interface portion 122 typically extends from a portion of the tire interface portion 120 inwardly toward a center of the tire interface portion 120 (which coincides with the rotational axis of the wheel assembly 100. The hub interface portion 122 may interface directly with a hub 130 of the wheel assembly 100, which may in turn be rigidly fixed or connected to an axle 132. The hub 130 may be operably coupled to the hub interface portion 122 via a plurality of lugs 134 (and corresponding lug nuts) that extend from the hub 130 through the hub interface portion 122. The lug nuts are then attached to distal ends of the lugs 134 to hold the hub 130 in a fixed state relative to the hub interface portion 122. Any turning or rotation of the hub 130 (via turning or rotation of the axle 132) therefore necessarily results in corresponding turning or rotation of the hub interface portion 122, which carries both the tire interface portion 120 and the tire 110 in rotation as well.

The hub interface portion 122 may be physically structured in any number of ways, and generally tends to be the most visible and distinctive portion of the wheel assembly from an aesthetic perspective. In this regard, the hub interface portion 122 faces outwardly toward and external viewer of the vehicle on which the wheel assembly 100 resides. Due to its highly visible context, the functional aspects of the design of the hub interface portion 122 are often coupled with ornamental aspects in any final design, and these designs may vary greatly. Thus, for example, the hub interface portion 122 may be embodied as a metallic plate structure extending from some portion of the tire interface portion 120 inwardly toward the center of the tire interface portion 120. The metallic plate structure may include an inner plate portion in which receiving orifices are formed to receive the lugs 134, and the inner plate portion may lie in a plane perpendicular to the rotational axis of the wheel assembly 100 (defined by an axis of the axle 132). In some cases, one or more additional annular plates (e.g., shaped individually like washers) may be formed outside the inner plate portion to fill the space between, and connect, inner plate portion to the tire interface portion 120. These additional annular plates, regardless of number, may be in planes also perpendicular to the rotational axis of the wheel assembly 100, or at an angle thereto in order to define any desirable aesthetic appearance. Moreover, the annular plates may have portions raised, removed, or otherwise structured to define any of various desirable designs. For example, the annular plate may be defined by removal of material as a collection of spokes extending from some portion of the tire interface portion 120 inwardly toward the center of the tire interface portion 120. The spokes, if employed, can take many different forms and the angles, thicknesses, numbers, and various other variable aspects of their design may vary widely. Other alternatives will also be easily appreciated by one of skill in the art.

To rotate the axle 132, and consequently also the hub 130, hub interface portion 122, tire interface portion 120 and the tire 110, an electric motor assembly may be employed. The electric motor assembly may include a rotor 140, a stator 150, and power electronics 160. The power electronics 160 may receive power from a battery 170 of the vehicle, and may control the application of current to the stator 150 to define a rotating field that operably couples the rotor 140 to the stator 150 to turn the rotor 140 based on the rotating field. The operating of the rotor 140 and stator 150 in this regard, is conventional and well understood by one of skill in the art, in addition to being outside the scope of this disclosure. However, for an in-wheel hub motor, the coupling of the rotor 140 to the axle 132 and/or hub 130 represents an area of interest since such coupling adds additional unsprung mass to the vehicle, as noted above.

In this regard, for example, the rotor 140 may be mounted onto the hub 130 such that the rotation of the rotor 140 (responsive to the rotating field of the stator 150) carries the hub 130 (and the corresponding components operably coupled thereto as noted above) in corresponding rotation. The rotor 140 is typically mounted to the hub 130 via a plurality of fasteners 142, which add to the component count of the wheel assembly 100 and unsprung mass of the vehicle. Notably, although the rotor 140 is shown adjacent to the stator 150, it should be appreciated that the rotor 140 could alternatively extend inside or outside of a circumference of the stator 150 in other cases, and the depiction is merely meant to be exemplary of closeness sufficient to enable the rotor 140 to move with respect to the stator 150 based on movement of the rotating field formed in the stator 150 based on input from the power electronics 160.

As shown in FIG. 1, a brake assembly 180 may be disposed proximate to the wheel assembly 100, and the brake assembly 180 may include calipers, rotors, discs, or various other frictional braking components and/or regenerative braking components in various embodiments.

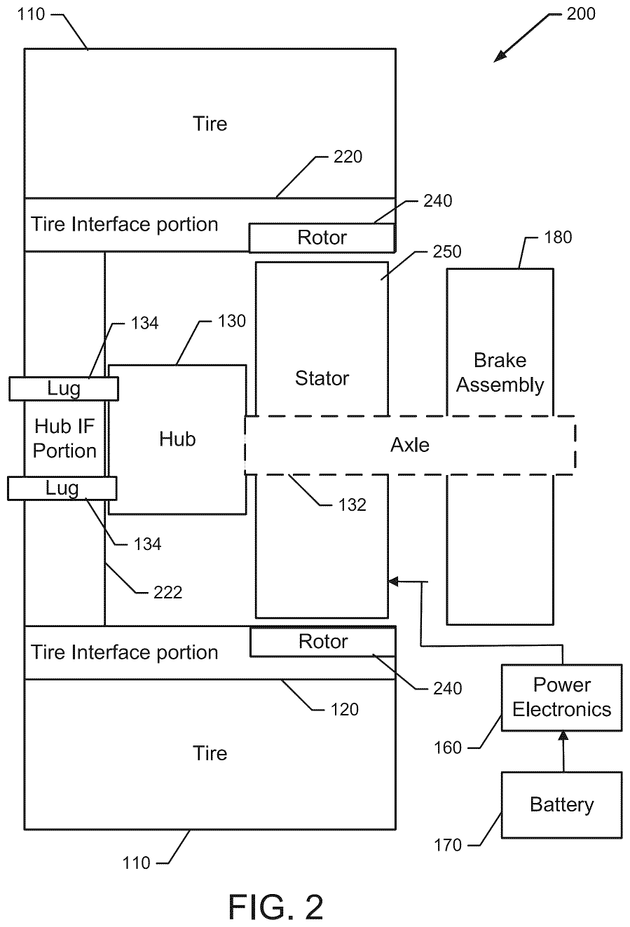

Since it may be desirable to reduce part count, and thereby also lower complexity, increase efficiency, and lower unsprung mass, some example embodiments may aim to advance upon the conventional design of FIG. 1. In this regard, FIG. 2 provides an architecture for one such advanced design in the form of wheel assembly 200. Although many parts of the wheel assembly 200 are the same as those of the wheel assembly 100 of FIG. 1, and therefore are labeled with the same reference numerals, some new structures and arrangement are included, and will be discussed in greater detail below.

Referring now to FIG. 2, a tire interface portion 220 may be modified such that rotor 240 and the tire interface portion 220 are integrally formed as a single part or combined assembly that lacks any fasteners therebetween. As noted above, although the integration of the combined assembly in this example places the rotor 240 outside the circumference of the stator 250, the rotor 240 could alternatively be adjacent to or inside of the stator 250 so long as the rotor 240 remains integrally formed with the tire interface portion 220 of the rim. The particular example arrangement shown enables the stator 250 to be inserted into the tire interface portion 220 (and therefore inside the rim, or inside the circumferential extent of the rim), which may result in space saving relative to some alternative structures. Moreover, although hub interface portion 222 could be identical to that of the example of FIG. 1, some modifications may further be made that will be discussed in greater detail below.

In the example of FIG. 2, the power electronics 160 may generate the rotating field in the stator 250 and the rotor 240 (and tire interface portion 220) may move about the stator 250 accordingly. The rotor coils or windings of the rotor 240 may therefore be integrated into the tire interface portion 220. However, the structures of the tire interface portion 220 for supporting and retaining the tire 110 could alternatively be considered to be integrally formed onto the rotor 240 in an equally valid paradigm. In an example embodiment, the rotor 240 and the tire interface portion 220 may be cast, forged, or otherwise formed integrally into a single component referred to as the combined assembly. In this regard, no fasteners may be needed to join the rotor 240 and the tire interface portion 220. By virtue of this structure, the hub interface portion 222 may move with the tire interface portion 220 and thereby also rotate the hub 130 and axle 132. Braking forces may be applied to the axle 132 or another component of the wheel assembly 200 via the brake assembly 180.

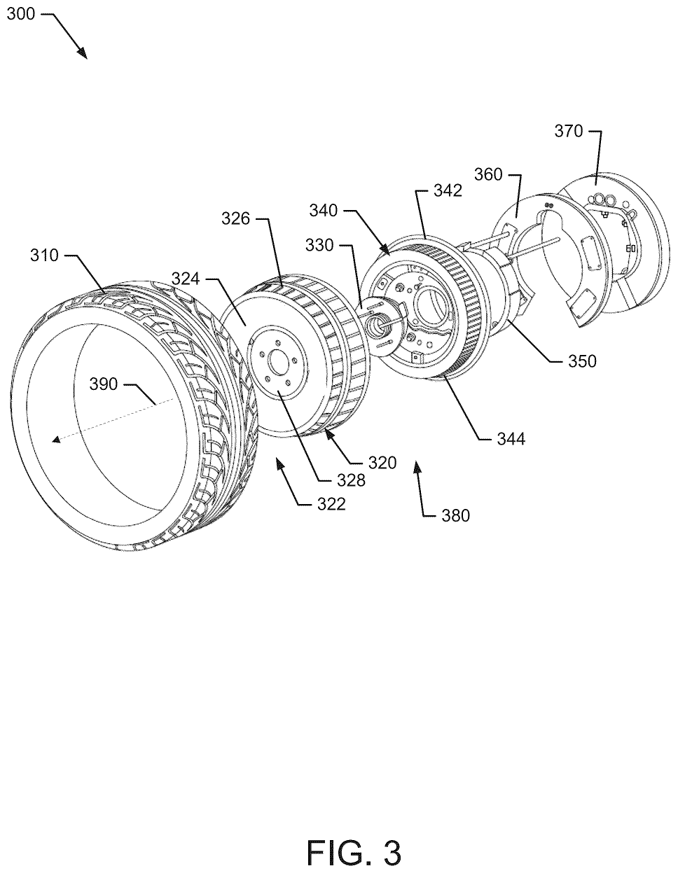

FIG. 3 illustrates an exploded perspective view of specific example structure that may be used to define the wheel assembly 200 of FIG. 2. In this regard, the wheel assembly 300 of FIG. 3 includes a tire 310, a rim/rotor combined assembly 320 and a hub 330 along with a stator assembly 340, a capacitor ring 350, power electronics 360 and a cover assembly 370 forming a protective cover for electrical components. Notably, the bead of the tire and bead engaging portions of the rim/rotor combined assembly 320 are removed to enhance visibility of other portions of these respective components. The rotor portion of the rim/rotor combined assembly 310 may form a part of an electric motor assembly 380 along with the stator assembly 340, the capacitor ring 350, the power electronics 360 and the cover assembly 370.

The stator assembly 340 of this example includes a mounting plate 342 to which annularly arranged stator coils 344 are mounted. In this example, the stator coils 344 are mounted on a side of the mounting plate 342 that faces an outer side 322 of the rim/rotor combined assembly 320, and therefore faces outwardly with respect to a longitudinal centerline of the vehicle on which the wheel assembly 300 is mounted. This enables the stator coils 344 to be inserted into the inner side of the rim/rotor combined assembly 320 (i.e., the side of the rim/rotor combined assembly 320 opposite the outer side 322) such that the mounting plate 342 may abut against a peripheral edge of the inner side of the rim/rotor combined assembly 320. An opening may be formed in the center of the mounting plate 342 to allow an axle of the vehicle to pass through for engagement with the hub 330, which may be disposed between the rim/rotor combined assembly 320, and the mounting plate 342. In some cases, the opening may be large enough to permit freedom of movement of the axle within the opening responsive to compression and rebound of the suspension system.

In an example embodiment, the capacitor ring 350 and the power electronics 360 may further be enclosed between the mounting plate 342 and the cover assembly 370 to protect the capacitor ring 350 and the power electronics 360 from debris or other external objects, moisture, and the like. Although fasteners may be used to attach the cover assembly 370 to the mounting plate 342, the mounting plate 342 need not be fastened itself to the rim/rotor combined assembly 320. In such a case, the only fasteners attaching to the rim/rotor combined assembly 320 may be the lugs and corresponding lug nuts that engage the rim/rotor combined assembly 320 to the hub 330 at a hub interface portion 324 of the rim/rotor combined assembly 320, which may extend inwardly from a tire interface portion 326 defining a periphery of the rim/rotor combined assembly 320. As indicated previously, the rotor of the electric motor assembly 380 is integrated into the tire interface portion 326 of the rim/rotor combined assembly 320.

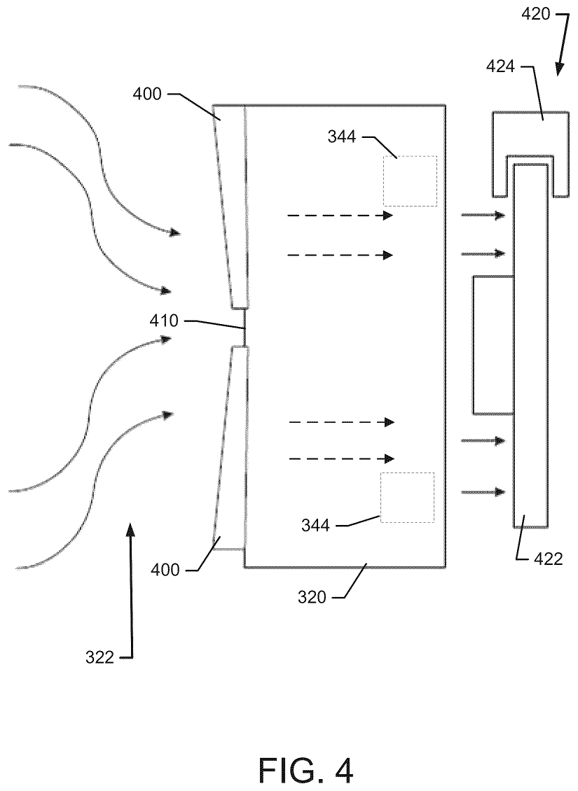

The hub interface portion 324 may further include an inner plate portion 328 in which receiving openings or apertures for receiving the lugs are formed. The inner plate portion 328 is a flat plate-like metallic member that lies in a plane substantially perpendicular to the rotational axis 390 of the tire 310 (and the hub 330 and axle). Portions of the hub interface portion 324 outside the inner plate portion 328 may be considered to be an annular plate that extends outwardly to the tire interface portion 326 (as described above). In an example embodiment, as shown in FIG. 4, airflow generation elements 400 may be formed at or on the annular plate 410 of the rim/rotor combined assembly 320. These airflow generation elements 400 may, responsive to rotation of the wheel assembly 300, drive airflow from the outer side 322 through the rim/rotor combined assembly 320, and inwardly toward components of a brake assembly 420 including, for example, a brake rotor 422 and brake caliper 424 as shown in FIG. 4, to provide cooling to the brake assembly 420. The airflow, by virtue of its passing through the rim/rotor combined assembly 320 may also provide cooling to the rotor and stator within the confines of the rim/rotor combined assembly 320. Moreover, given that the faster the wheel assembly 300 rotates, the faster the airflow generation elements 400 are driven, the fact that wheel speed will often be dictated by the amount of current applied to the stator coils 344 of the electric motor assembly 380, means that the amount of cooling airflow is in direct proportion to the current draw of the stator coils 344.

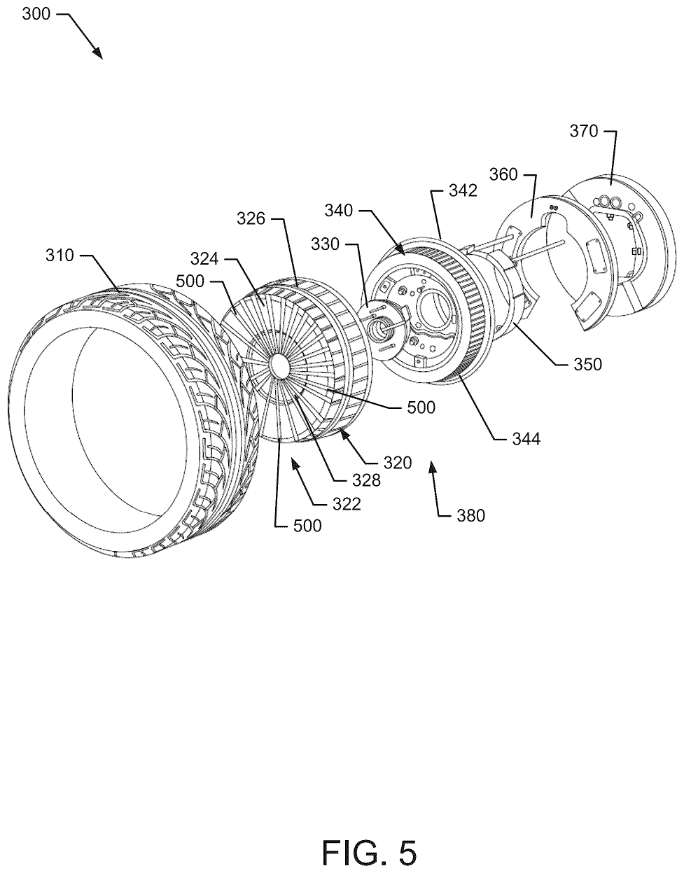

The airflow generation elements 400 may take a number of different forms. For example, as shown in FIG. 5, a plurality of aerodynamic vanes 500 may be provided on or integrally formed into the hub interface portion 324. Thus, for example, openings may be formed in the hub interface portion 324 for the passage of air through the hub interface portion 324 responsive to airflow generated by rotation of the aerodynamic vanes 500. The aerodynamic vanes 500 may be integrated into spokes, or spoke-like structures of the hub interface portion 324 to provide added aesthetic appeal in some cases. However, the specific form or design of the aerodynamic vanes 500 is not as important as their function of driving airflow through the hub interface portion 324 from the outer side 322 inwardly toward the stator coils 344 and the brake assembly 420.

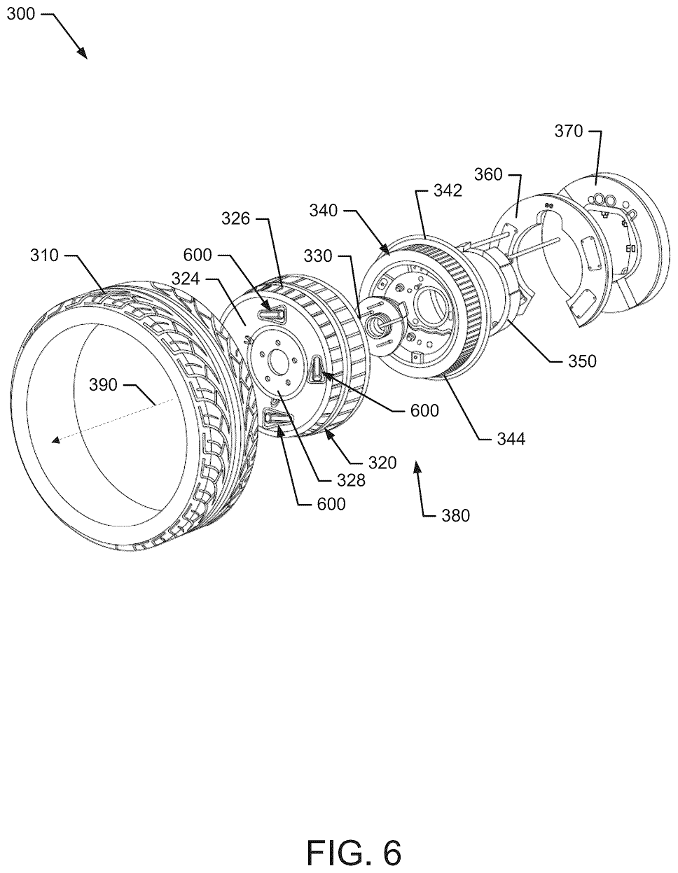

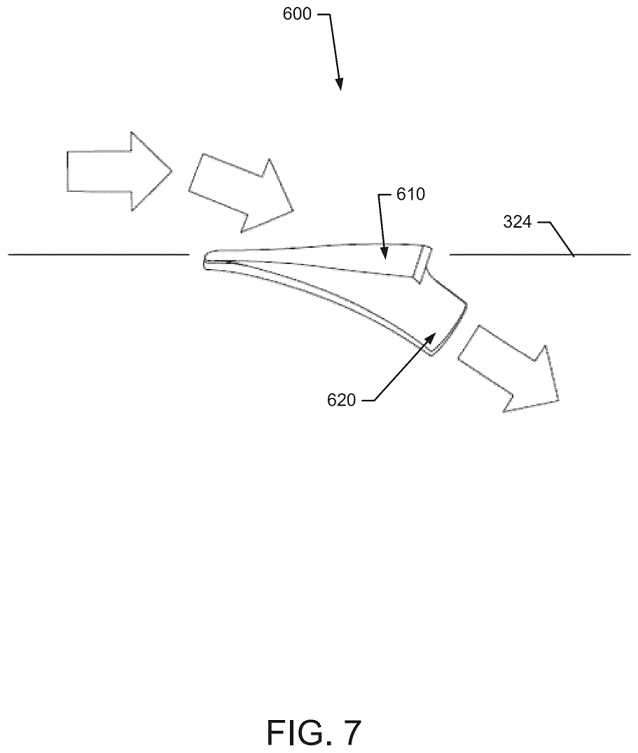

Another form that the airflow generation elements 400 may take is shown in FIG. 6. In this regard, in FIG. 6, a plurality of aerodynamic ducts 600 that act as air scoops may be operably coupled to or disposed in the annular plate of the hub interface portion 324. In an example embodiment, the aerodynamic ducts 600 may extend tangentially with respect to the rotational axis 390 between the tire interface portion 326 and the inner plate portion 328 to direct airflow from the outer side 322 of the rim/rotor combined assembly 320 toward the brake assembly 420 and electric motor assembly 380 disposed on an inner side of the rim/rotor combined assembly 320. In some cases, the aerodynamic ducts 600 may be structured to act as an air scoop (e.g., a National Advisory Committee for Aeronautics (NACA) duct) to effectively draw airflow into the aerodynamic ducts while limiting the disturbance to air flow around the structure in which the air scoop is positioned. Thus, in this case, as shown in FIG. 7, the aerodynamic ducts 600 may each include a scoop portion 610 disposed on the outer side 322 of the hub interface portion 324 and a duct portion 620 extending through the hub interface portion 324 to direct the airflow toward the brake assembly 420 and/or the components of the electric motor assembly 380. In an example embodiment, the scoop portion 610 may be conformal with (or nearly conformal with—i.e., having a very small (if an) amount of protrusion away from a surface of the hub interface portion 324) while still having a larger cross sectional area larger than a cross sectional area of the duct portion 620. The scoop portion 610 may therefore reduce any drag created by rotation on the wheel assembly 300, while still effectively drawing air into the aerodynamic duct 600 and increasing speed of the airflow as it passes through the duct portion 620 toward the components being cooled.

A wheel assembly for a vehicle according to an example embodiment may therefore include a rim on which a tire is mountable, and an electric motor assembly operably coupled to the rim. The electric motor assembly may include a rotor, a stator and power electronics. The electric motor assembly may be operably coupled to a battery of the vehicle to provide motive force to the rim to rotate the tire with the rim responsive to application of a rotating electric field in the stator that causes corresponding rotation of the rotor under control of the power electronics. The rim and the rotor are integrally formed as a combined assembly without any fastening means therebetween.

The wheel assembly (or a vehicle including the same) of some embodiments may include additional features, modifications, augmentations and/or the like to achieve further objectives or enhance performance of the device. The additional features, modifications, augmentations and/or the like may be added in any combination with each other. Below is a list of various additional features, modifications, and augmentations that can each be added individually or in any combination with each other. For example, the rim and rotor may be cast together to form the combined assembly, or in some alternatives, the rim and rotor may be forged together to form the combined assembly. In an example embodiment, a hub and axle may be operably coupled to the rim via a plurality of lugs, and no fasteners attach external components to the rim other than the lugs. In some cases, the stator may be operably coupled to a mounting plate disposed opposite the rim with respect to the hub. In an example embodiment, the electric motor assembly may further include a capacitor ring disposed between the power electronics and the stator. In some cases, a protective cover may operably couple to the mounting plate to enclose the capacitor ring and the power electronics between the protective cover and the mounting plate. In an example embodiment, the stator may be inserted inside the rim to operably couple the stator to the rotor. In some cases, the rim comprises a hub interface portion and a tire interface portion, and the rotor may be integrated into the tire interface portion. In an example embodiment, the hub interface portion may include an annular plate disposed in a plane substantially perpendicular to a rotational axis of the rim, and a plurality of airflow generation elements (e.g., a plurality of aerodynamic vanes, or a plurality of aerodynamic ducts) may be operably coupled to or disposed in the annular plate. In some cases, the aerodynamic vanes may extend radially outwardly with respect to the rotational axis toward the tire interface portion and direct airflow from an outer side of the rim toward a brake assembly of the vehicle disposed on an inner side of the rim. In an example embodiment, the aerodynamic ducts may extend tangentially with respect to the rotational axis toward the tire interface portion and direct airflow from an outer side of the rim toward a brake assembly of the vehicle disposed on an inner side of the rim. In some cases, the aerodynamic ducts may include a scoop portion disposed on the outer side of the rim and a duct portion extending through the annular plate to direct the airflow toward the brake assembly. In an example embodiment, the scoop portion has a cross sectional area larger than a cross sectional area of the duct portion. In some cases, the plurality of airflow generation elements may be disposed on the annular plate to generate and direct airflow from an outer side of the rim toward the stator disposed on an inner side of the rim to cool the stator such that the airflow is in direct proportion to a current draw of the stator.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed is:

1. A wheel assembly for a vehicle, the wheel assembly comprising:
a rim on which a tire is mountable; and
an electric motor assembly operably coupled to the rim, the electric motor assembly comprising a rotor, a stator and power electronics,
wherein the electric motor assembly is operably coupled to a battery of the vehicle to provide motive force to the rim to rotate the tire with the rim responsive to application of a rotating electric field in the stator that causes corresponding rotation of the rotor under control of the power electronics, and
wherein the rim and the rotor are integrally formed as a combined assembly without any fastening means therebetween.

2. The wheel assembly of claim 1, wherein the rim and rotor are cast together to form the combined assembly.

3. The wheel assembly of claim 1, wherein the rim and rotor are forged together to form the combined assembly.

4. The wheel assembly of claim 1, wherein a hub and axle are operably coupled to the rim via a plurality of lugs, and no fasteners attach to the rim other than the lugs.

5. The wheel assembly of claim 4, wherein the stator is operably coupled to a mounting plate disposed opposite the rim with respect to the hub.

6. The wheel assembly of claim 5, wherein the electric motor assembly further comprises a capacitor ring disposed between the power electronics and the stator.

7. The wheel assembly of claim 6, wherein a protective cover operably couples to the mounting plate to enclose the capacitor ring and the power electronics between the protective cover and the mounting plate.

8. The wheel assembly of claim 1, wherein the stator is inserted inside the rim to operably couple the stator to the rotor.

9. The wheel assembly of claim 1, wherein the rim comprises a hub interface portion and a tire interface portion, and
wherein the rotor is integrated into the tire interface portion.

10. The wheel assembly of claim 9, wherein the hub interface portion includes an annular plate disposed in a plane substantially perpendicular to a rotational axis of the rim, and
wherein a plurality of aerodynamic vanes are operably coupled to the annular plate.

11. The wheel assembly of claim 10, wherein the aerodynamic vanes extend radially outwardly with respect to the rotational axis toward the tire interface portion and direct airflow from an outer side of the rim toward a brake assembly of the vehicle disposed on an inner side of the rim.

12. The wheel assembly of claim 9, wherein the hub interface portion includes an annular plate disposed in a plane substantially perpendicular to a rotational axis of the rim, and
wherein a plurality of aerodynamic ducts are disposed in the annular plate.

13. The wheel assembly of claim 12, wherein the aerodynamic ducts extend tangentially with respect to the rotational axis toward the tire interface portion and direct airflow from an outer side of the rim toward a brake assembly of the vehicle disposed on an inner side of the rim.

14. The wheel assembly of claim 13, wherein the aerodynamic ducts comprise a scoop portion disposed on the outer side of the rim and a duct portion extending through the annular plate to direct the airflow toward the brake assembly.

15. The wheel assembly of claim 14, wherein the scoop portion has a cross sectional area larger than a cross sectional area of the duct portion.

16. The wheel assembly of claim 9, wherein a plurality of airflow generation elements are disposed on hub interface portion to generate and direct airflow from an outer side of the rim toward the stator disposed on an inner side of the rim to cool the stator such that the airflow is in direct proportion to a current draw of the stator.

17. An electric motor assembly for a vehicle, the electric motor assembly comprising:
a battery;
a rotor;
a stator; and
power electronics operably coupled to the battery to receive power for controlling application of current to the stator to generate a rotating electric field in the stator that causes corresponding rotation of the rotor under control of the power electronics,
wherein the electric motor assembly is operably coupled to a wheel rim on which a tire is mountable, and
wherein the rim and the rotor are integrally formed as a combined assembly without any fastening means therebetween.

18. The electric motor assembly of claim 17, wherein the rim comprises a hub interface portion and a tire interface portion, and
wherein the rotor is integrated into the tire interface portion.

19. The electric motor assembly of claim 17, wherein a hub and axle are operably coupled to the rim via a plurality of lugs, and no fasteners attach to the rim other than the lugs, wherein the stator is operably coupled to a mounting plate disposed opposite the rim with respect to the hub.

20. The electric motor assembly of claim 19, further comprising a capacitor ring disposed between the power electronics and the stator, wherein a protective cover operably couples to the mounting plate to enclose the capacitor ring and the power electronics between the protective cover and the mounting plate.
